(19) United States
(12) Patent Application Publication
(10) Pub. No.: US 2018/0174278 A1
(43) Pub. Date: Jun. 21, 2018

(54) DISTORTED IMAGE CORRECTING APPARATUS AND METHOD

(71) Applicant: MStar Semiconductor, Inc., Hsinchu Hsien (TW)

(72) Inventors: Jen-Shi WU, Hsinchu Hsien (TW); Chung-Yi CHEN, Hsinchu Hsien (TW); Cheng-Liang WANG, Hsinchu Hsien (TW)

(21) Appl. No.: 15/668,835

(22) Filed: Aug. 4, 2017

(30) Foreign Application Priority Data
Dec. 19, 2016 (TW) 105141985

(51) Int. Cl. G06T 5/00; G06T 1/60

(52) U.S. Cl. CPC G06T 5/006; G06T 1/60

(57) ABSTRACT

A distorted image correcting method is applied to a distorted image correcting apparatus to correct a distorted image to further generate a corrected image. The image correcting apparatus includes a buffer, which includes a memory block having a capacity that is smaller than a size of a data block of the distorted image. The distorted image correcting method includes: controlling a memory controller to retrieve M sets of segment data of the data block to the memory block, where M is smaller than N; and generating a part of the corrected image according to the M sets of segment data.

This application claims the benefit of Taiwan application Serial No. 105141985, filed Dec. 19, 2016, the subject matter of which is incorporated herein by reference.

### BACKGROUND OF THE INVENTION

### Field of the Invention

The invention relates in general to image processing, and more particularly to a distorted image correcting apparatus and method.

### Description of the Related Art

When forming an image through an imaging lens, the image is distorted due to optical distortion to appear arcuate or ellipsoidal. Thus, the distorted image needs to be corrected to obtain a corrected image.

FIG. 1 shows a schematic diagram of a buffer capacity needed for correcting a distorted line of a distorted image in the prior art. In the prior rat, to correct a distorted horizontal line 108 of a distorted image 104, frame data that envelops the entire distorted horizontal line 108 is loaded from a dynamic random access memory (DRAM) to a buffer memory (e.g., a static random access memory (SRAM)), and a subsequent correcting process is performed to obtain an horizontal line 110 in a corrected image 102.

### SUMMARY OF THE INVENTION

It is an object of the present invention to provide a distorted image correcting apparatus and method capable of reducing the amount of a buffer memory used without affecting the correction capability, so to enhance the utilization efficiency of the buffer memory and to reduce the amount of system resources used.

The present invention discloses a distorted image correcting apparatus for correcting a distorted image to generate a corrected image. The distorted image correcting apparatus includes: a buffer memory, including a memory block, the memory block having a capacity smaller than a size of a data block that includes N sets of segment data; a memory controller, retrieving the data block from a memory to the buffer memory; a configuring circuit, controlling the memory controller according to a distortion map to retrieve the M sets of segment data in the data block to the memory block, where M is smaller than N; and a correcting circuit, generating a part of the corrected image according to the M sets of segment data in the buffer memory.

The present invention further discloses a distorted image correcting method that is applied to a correcting apparatus to correct a distorted image to generate a corrected image. The correcting apparatus includes a buffer memory, which has a capacity smaller than a size of a data block of the distorted image. The data block includes N sets of segment data. The distorted image correcting method includes: controlling a memory controller according to a distortion map to retrieve M sets of segment data from the data block to the memory block, where M is smaller than N; and generating a part of the corrected data according to the M sets of segment data.

The above and other aspects of the invention will become better understood with regard to the following detailed description of the non-limiting embodiments. The following description is made with reference to the accompanying drawings.

### BRIEF DESCRIPTION OF THE DRAWINGS

FIG. 1 is a schematic diagram of a buffer memory capacity needed for correcting a distorted line in a distorted image in the prior art;

FIG. 2 is a block diagram of a distorted image correcting apparatus according to an embodiment of the present invention;

FIG. 3 is a schematic diagram of an example of a distorted image;

FIG. 4A to FIG. 4D are an example of a data block corresponding to a distorted segment 312-1 and contents stored in the data block;

FIG. 5A and FIG. 5B are an example of a data block corresponding to a distorted segment 313-1 and contents stored in the data block; and

FIG. 6 and FIG. 7 are flowcharts of a distorted image correcting method according to an embodiment of the present invention.

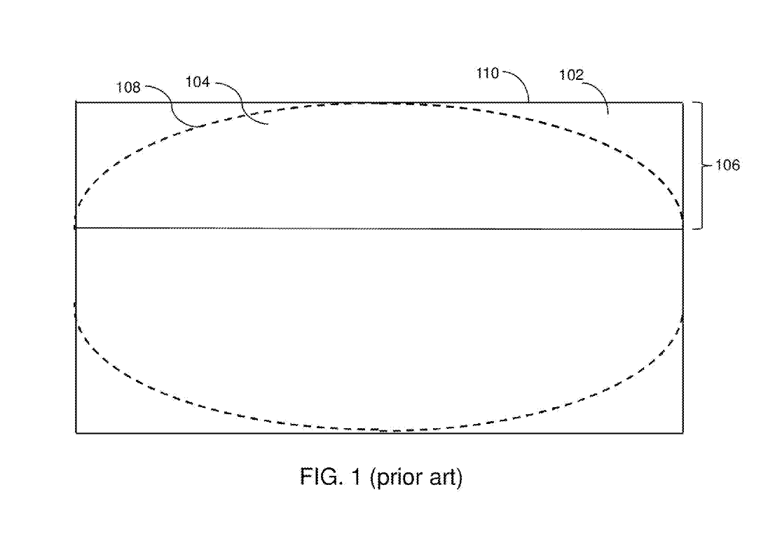

### DETAILED DESCRIPTION OF THE INVENTION

The present invention discloses a distorted image correcting apparatus and method. A part of the elements included in the apparatus and system may be individually known elements. Without affecting the full disclosure and possible implementation of the apparatus, details of the known elements are omitted. Further, a part of all of the method may be in form of software and/or firmware, and may be performed be the apparatus or the present invention or an equivalent device. In possible implementation, one skilled person in the art may choose equivalent elements or steps to implement the present invention based on the disclosure of the application. That is, the implementation of the present invention is not limited by the embodiments disclosed in the application.

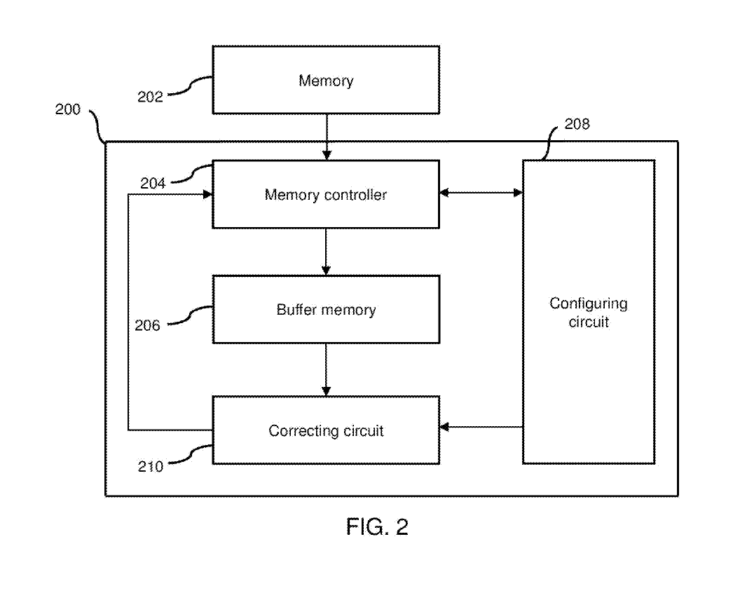

FIG. 2 shows a block diagram of a distorted image correcting apparatus according to an embodiment of the present invention. As shown in FIG. 2, a distorted image correcting apparatus 200, for correcting a distorted image to generate a corrected image, includes a memory controller 204, a buffer memory 206, a configuring circuit 208 and the correcting circuit 210. Coupling among these elements may be learned from the drawing, and shall be omitted for brevity. In one embodiment, the memory controller 204, the buffer memory 206, the configuring circuit 208 and the correcting circuit 210 are located in a same integrated circuit, and the memory 202 is disposed outside the integrated circuit. In another embodiment, the memory 202, the memory controller 204, the buffer memory 206, the configuring circuit 208 and the correcting circuit 210 may be located in a same integrated circuit. For example, the memory 202 is a dynamic random access memory (DRAM), and the buffer memory 206 is a static random access memory (SRAM). The configuring circuit 208 may be implemented by one or multiple processors incorporating software.

A distortion map records a position mapping relationship of a plurality of pixels in the distorted image and the corrected image. Thus, the correcting apparatus 200 may correct the distorted image to generate the corrected image according to the distortion map. For example, the distortion map is stored in a flash memory. For example, the distortion map records that, a pixel P(128, 2) in the corrected image corresponds to a pixel P′(128, 80) in the distorted image. Thus, the correcting apparatus 200 uses the pixel value of the pixel P′(128, 80) in the distorted image as the pixel value of the pixel P(128, 2) in the corrected image to correct the distorted image.

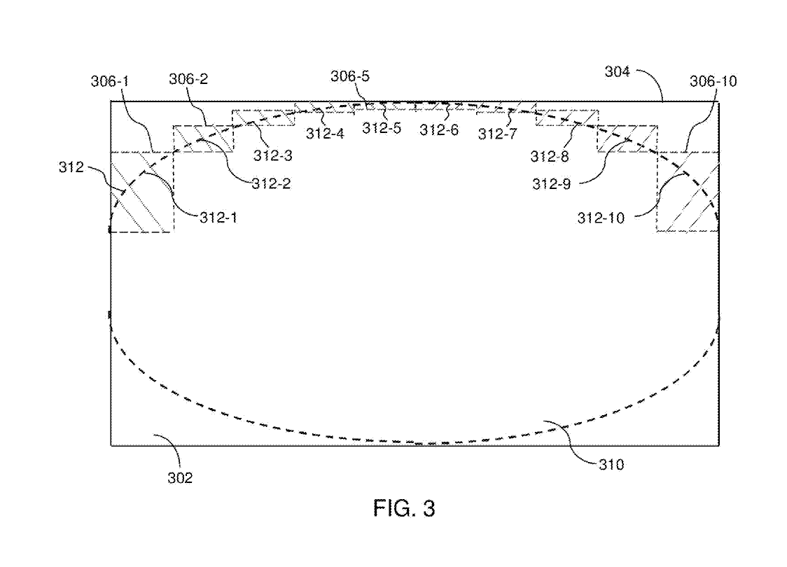

In practice, each distorted horizontal line is corrected in a unit of a segment. The buffer memory 206 includes a plurality of memory blocks, which respectively store data blocks of the corresponding segments for the correcting circuit 210 to correct the segments. For example, FIG. 3 shows a schematic diagram of an example of a distorted image. A distorted image 310 includes a distorted horizontal line 312, which is divided into 10 segments 312-1 to 312-10 to be corrected. Data blocks 306-1 to 306-10 are for respectively correcting the segments 312-1 to 312-10. In this embodiment, the distorted horizontal line 312 is divided into 10 segments to be corrected, as an example for explaining the present invention rather than a limitation to the present invention. That is, a distorted horizontal line may be divided into K sets of distorted data, where K is a positive integer greater than 1.

Similarly, when the correcting circuit 210 corrects a next distorted horizontal line, memory blocks of the buffer memory 206 may respectively store data blocks of segments corresponding to the next distorted horizontal line. It is known that, one memory block in the buffer memory 206 may store different data blocks. Due to different distortion levels, the sizes of data blocks of different segments also vary, and the data block gets larger as the distortion level of a segment is larger. In general, to reduce the amount of memory bandwidth used, the capacity of the memory blocks in the buffer memory 206 may be designed to be equal to or greater than the data size of the data block having the largest data size among all of the corresponding data blocks. Taking a 1280×720 distorted image for instance, as one frame includes 720 horizontal lines, each memory block corresponds to 720 data blocks. If the data sizes of these 720 data blocks are between 5 KB and 8 KB, the capacity of the memory block corresponding to these 720 data blocks is designed to be 8 KB or slightly larger than 8 KB.

To reduce memory costs, the capacity of one or multiple memory blocks in the buffer memory 206 may be designed to be smaller than the data size of the data block having the largest data size among all of the corresponding data blocks. In continuation of the above example, if the data sizes of these 720 data blocks are between 5 KB and 8 KB, the capacity of the memory block corresponding to these 720 data blocks is designed to be 6 KB.

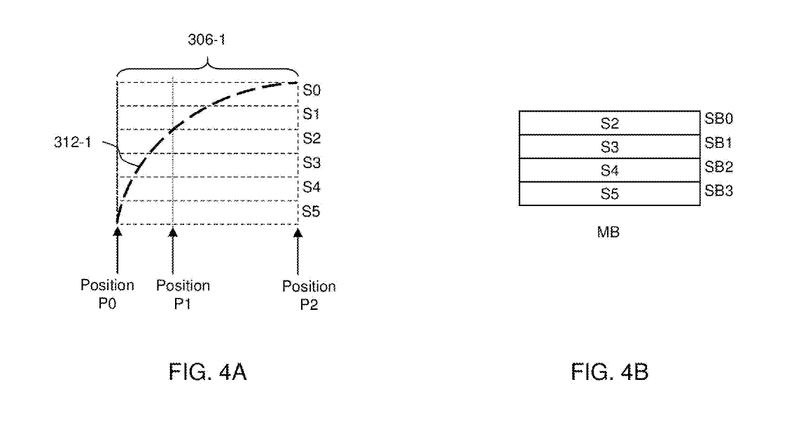

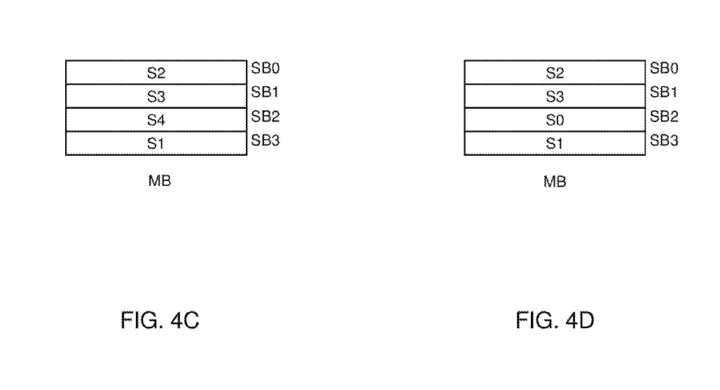

Referring to FIGS. 4A to 4D, details of a distorted image correcting method performed by the distorted image correcting apparatus 200 when the capacity of the memory blocks of the buffer memory 206 is smaller than the data size of the data blocks are given below. As shown in FIG. 4A, the data block 306-1 includes six sets of segment data S0 to S5 for correcting the distorted segment 312-1. FIG. 4B to 4D are memory blocks MB in the buffer memory 206 for storing the data block 306-1. As shown in FIG. 4B to 4D, the memory block MB includes four sub-blocks SB0 to SB3, each of which stores one set of segment data. Thus, the memory block MB stores four sets of segment data at most.

In this embodiment, the correcting circuit 210 performs correction along a direction from a position P0 towards a position P2. In other words, the correcting circuit 210 generates corrected segments by sequentially referring to the segment data S5, S4, S3, S2, S1 and S0. Thus, the configuring circuit 208 controls the memory controller 204 according to the distortion map to retrieve the segment data S2 to S5 from the memory 202, and to store the segment data S2 to S5 to the memory block MB for the correcting circuit 210 to correct the distorted segment 312-1, as shown in FIG. 4B.

Next, the correcting circuit 210 refers to the data block 306-1 in the memory block MB according to the distortion map to correct the distorted segment 312-1 to further generate a part of the corrected image. For example, when a position under correction is the position P0, the correcting circuit 210 refers to the segment data S5 in the memory block MB to generate a corrected segment. Similarly, the correcting circuit 210 sequentially refers to the segment data S4, S3 and S2 in the memory block MB to generate corrected segments.

Among the segment data stored in the memory block MB, the segment that is first used in the correction process is defined as a starting segment, the segment that is last used in the correction process is defined as an ending segment, and the sub-block storing the starting segment in the memory block MB is defined as a starting sub-block. Further, the configuring circuit 208 records a memory status of the memory block MB. The memory status includes a starting segment index I_{SI}, a starting sub-block index I_{SBI} and an ending segment index I_{SE} in the memory block MB. For example but not limited to, the memory status is stored in an SRAM. Taking the memory block MB in FIG. 4B for example, the starting segment index I_{SI} corresponds to the segment data S5, the starting sub-block index I_{SBI} corresponds to the sub-block SB3, and the ending segment index I_{SE} corresponds to the segment data S2.

On the other hand, the correcting circuit 210 informs the configuring circuit of a position under correction, and the configuring circuit 210 determines whether to update the memory block MB according to the position under correction, the distortion map and the memory status of the memory block MB. More specifically, the configuring circuit 208 identifies reference segment data according to the position under correction and the distortion map, and then determines whether the reference segment data is stored in the memory block MB according to the starting segment index I_{SI} and the ending segment index I_{SE} in the memory status to determine whether to update the memory block MB.

For example, assuming that the position under correction is P0, the configuring circuit 208 may identify that the reference segment data is the segment data S5 according to the position P0 and the distortion map, and then can determine that the reference segment data (the segment data S5) is stored in the memory block MB according to the starting segment index I_{SI} (corresponding to the segment data S5) and the ending segment index I_{SE} (corresponding to the segment data S2). Thus, the configuring circuit 208 does not control the memory controller 204 to update the memory block MB.

For another example, if the correction position is the position P1, the configuring circuit 208 may identify that the reference segment data is the segment data S1 according to the position P1 and the distortion map, and can determine that the segment data S1 (i.e., the reference segment data) is not stored in the memory block MB according to the starting segment index I_{SI} (corresponding to the segment data S5) and the ending segment index I_{SE} (corresponding to the segment data S2). Thus, the configuring circuit 208 controls the memory controller 204 to update the memory block MB. More specifically, the configuring circuit 208, according to the starting sub-block index I_{SBI} (corresponding to sub-block SB3), controls the memory controller 204 to write the segment data S1 (i.e., the reference segment data) to the sub-block SB3 (i.e., the starting sub-block) in the memory block MB according to the starting sub-block index (corresponding to the sub-block S3), so the segment data S5 originally stored in the sub-block SB3 is overwritten, as shown in FIG. 4C. Then, the correcting circuit 210 refers to the segment data S1 in the memory block MB to continue correcting the distorted segment 312-1 according to the distortion map.

Further, the configuring circuit 208 updates the memory status of the memory block MB to cause the starting segment index I_{SI} to correspond to the segment data S4, the starting sub-block index I_{SBI} to correspond to the sub-block SB2, and the ending segment index I_{SE} to correspond to the segment data S1.

Similarly, if the configuring circuit 208 identifies that the reference segment data is the segment data S0 according to the correction position from the correcting circuit 210 and the distortion map, the configuring circuit 208 can determine that the segment data S0 (the reference segment data) is not stored in the memory block MB according to the starting segment index I_{SI} (corresponding to the segment data S4) and the ending segment index I_{SE} (corresponding to the segment data S1). Thus, the configuring circuit 208 controls the memory controller 204 to write the segment data S0 (i.e., the reference segment data) to the sub-block SB2 (i.e., the starting sub-block) in the memory block MB according to the starting sub-block index I_{SBI} (corresponding to the sub-block SB2), so the segment data S4 originally stored is overwrite in the sub-block SB2, as shown in FIG. 4D. Next, the correcting circuit 210 refers to the segment data S0 in the memory block MB to continue correcting the distorted segment 312-1 along the direction towards the position P2 according to the distortion map to complete the correction on the distorted segment 312-1.

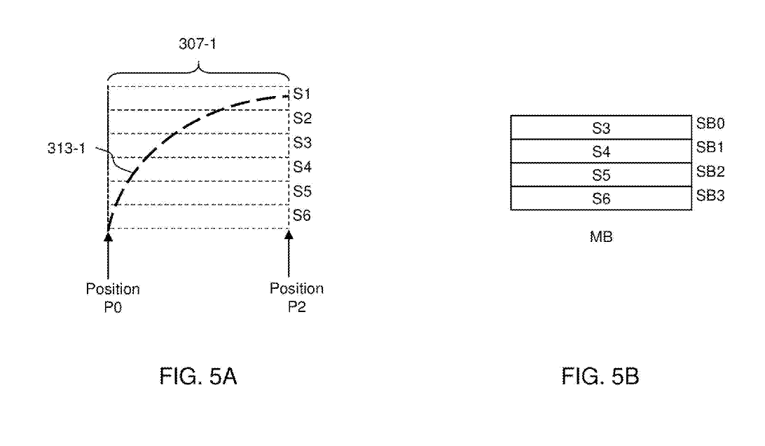

After the distorted segment 312-1 is completely corrected, the memory block MB of the buffer memory 206 then stores another data block instead, e.g., the data block 307-1 of the distorted segment 313-1. As shown in FIG. 5A, the data block 307-1 includes six sets of segment data S1 to S6 for correction.

In this embodiment, the correcting circuit 210 performs correction along the direction from the position P0 towards the position P2. In other words, the correcting circuit 210 sequentially refers to the segment data S6, S5, S4, S3, S2 and S1 to generate corrected segments. Thus, the configuring circuit 208 controls the memory controller 204 according to the distortion map to retrieve the segment data S3 to S6 from the memory 202 and store the segment data S3 to S6 to the memory block MB for the correcting circuit 210 to correct a distorted segment 313-1, as shown in FIG. 5B.

After the distorted segment 312-1 is completely corrected, the memory block MB of the buffer memory 206 is stored with the segment data S3, as shown in FIG. 4D. However, to correct a next distorted segment, the configuring circuit 208 still controls the memory controller 204 to retrieve the segment data S3 from the memory 202 and stores the segment data S3 to the memory block MB, as shown in FIG. 5B. In other words, when a next distorted segment is to be corrected, the configuring circuit 208 does not consider whether the currently stored segment data in the memory block MB is identical to the segment data to be retrieved to decide to retrieve the segment data needed for the reason of saving the memory bandwidth. The configuring circuit 208 directly retrieves the segment data needed, even if the segment data currently stored in the memory block may be repeatedly retrieved. In other words, when the segment data to be retrieved is identical to a segment data existing in the memory block MB, the configuring circuit 208 still controls the memory controller 204 to write the same segment data to the memory block MB. As such, determination time of the configuring circuit 208 may be eliminated to accelerate the correction speed and hence efficiency of the correcting apparatus 200. Details of subsequent correcting steps are similar and shall be omitted herein.

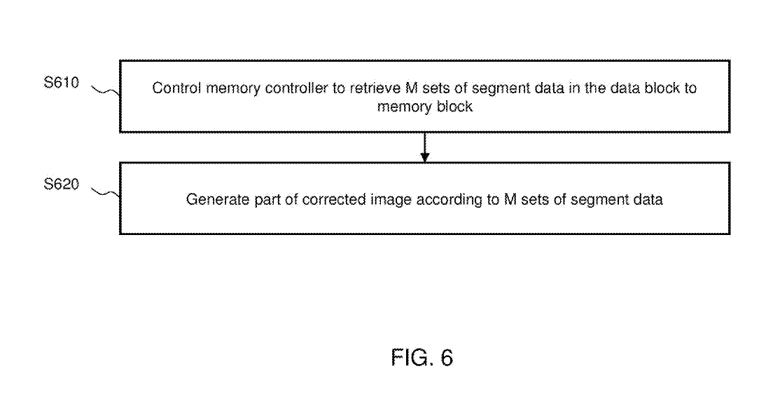

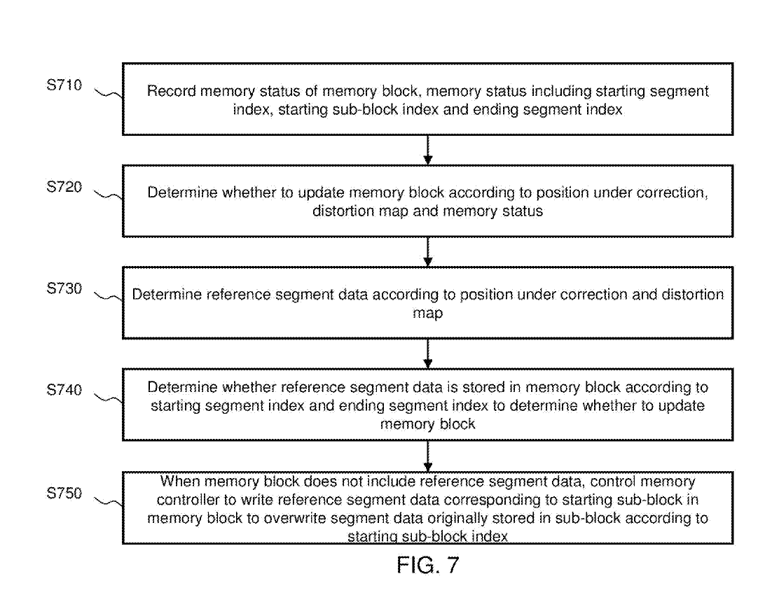

FIG. 6 to FIG. 7 show flowcharts of a distorted image correction method according to an embodiment of the present invention. The distorted image correcting method is applied to the foregoing distorted image correcting apparatus to retrieve data block of a distorted image from a memory to further generate a corrected image. The correcting method includes step S610 and step S620 in FIG. 6. In step S610, the data block includes N sets of segment data, where M and N are positive integers, and M is smaller than N. In one embodiment, step S610 is performed by the configuring circuit 208, and step S620 is performed by the correcting circuit 210. Associated details are disclosed as above, and shall be omitted herein.

Steps S710 to S750 in FIG. 7 may be steps between steps S610 and S620. In one embodiment, steps S710 to S750 may be performed by the configuring circuit 208, and associated details are as disclosed above and shall be omitted herein.

One person skilled in the art can understand details and variations of the method based on the disclosure of the apparatus in the above embodiments. More specifically, the technical features of the apparatus and method in the above embodiments may be reasonably applied to the method of this embodiment. Without affecting full disclosure and possible implementation of the method of the embodiment, such repeated details shall be omitted herein.

In conclusion, in the present invention, a buffer memory is divided into a plurality of memory blocks, and the memory capacity of at least one of the memory blocks is designed to be smaller than, among a plurality of image data blocks corresponding to the memory block, the data size of one image block that has a largest data size. Thus, the capacity that the buffer memory needs is reduced to reduce costs, and competing for hardware resources with other circuits in the system is eliminated.

While the invention has been described by way of example and in terms of the embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A distorted image correcting apparatus, for correcting a distorted image to generate a corrected image, comprising:
a buffer memory, comprising a memory block, wherein a capacity of the memory block is smaller than a size of a data block of the distorted image, and the data block comprises N sets of segment data;
a memory controller, retrieving the data block from a memory to the buffer memory;
a configuring circuit, controlling the memory controller according to a distortion map to retrieve M sets of segment data in the data block to the memory block, where M is smaller than N; and
a correcting circuit, generating a part of the corrected image according to the M sets of segment data in the buffer memory.

2. The distorted image correcting apparatus according to claim 1, wherein the configuring circuit further records a memory status of the memory block, and the memory status comprises a starting segment index, a starting sub-block index and an ending segment index.

3. The distorted image correcting apparatus according to claim 2, wherein the configuring circuit determines whether to update the memory block according to a position under correction, the distorted map and the memory status.

4. The distorted image correcting apparatus according to claim 3, wherein the configuring circuit determines whether to update the memory block by identifying reference segment data according to the position under correction and the distortion map, and determining whether the reference segment data is stored in the memory block according to the starting segment index and the ending segment index.

5. The distorted image correcting apparatus according to claim 4, wherein when the configuring circuit determines that the reference segment data is not stored in the memory block according to the starting segment index and the ending segment index, the configuring circuit controls the memory controller to update the memory block.

6. The distorted image correcting apparatus according to claim 5, wherein the configuring circuit controls the memory controller to update the memory block by controlling the memory controller according to the starting sub-block index to write the reference segment data to a sub-block corresponding to the starting sub-block index in the memory block to overwrite segment data originally stored in the sub-block.

7. The distorted image correcting apparatus according to claim 1, wherein the configuring circuit controls the memory controller to retrieve segment data of another data block to the memory block without considering whether there is any segment data existing in the memory block is identical to the segment data of another data block.

8. The distorted image correcting apparatus according to claim 7, wherein the segment data of another data block that the configuring circuit controls the memory controller to retrieve is identical to a segment data existing in the memory block.

9. A distorted image correcting method, applied to a correcting apparatus to correct a distorted image to generate a corrected image, the correcting apparatus comprising a buffer memory that comprises a memory block, a capacity of the memory block being smaller than a size of a data block of the distorted image, the data block comprising N sets of segment data, the method comprising:
controlling a memory controller according to a distortion map to retrieve M sets of segment data in the data block to the memory block, where M is smaller than N; and
generating a part of the corrected image according to the M sets of segment data.

10. The distorted image correcting method according to claim 9, further comprising:
recording a memory status of the memory block, the memory status comprising a starting segment index, a starting sub-block index and an ending segment index.

11. The distorted image correcting method according to claim 10, further comprising:
determining whether to update the memory block according to a position under correction, the distorted map and the memory status.

12. The distorted image correcting method according to claim 11, wherein the step of determining whether to update the memory block comprises:
identifying reference segment data according to the position under correction and the distortion map; and
determining whether the reference segment data is stored in the memory block according to the starting segment index and the ending segment index.

13. The distorted image correcting method according to claim 12, wherein the step of determining whether to update the memory block further comprises:
updating the memory block when it is determined that the reference segment data is not stored in the memory block.

14. The distorted image correcting method according to claim 13, wherein the step of updating the memory block further comprises:
controlling the memory controller according to the starting sub-block index to write the reference segment data to a sub-block corresponding to the starting segment index in the memory block to overwrite segment data originally stored in the sub-block.

15. The distorted image correcting method according to claim 9, further comprising:
controlling the memory controller to retrieve segment data of another data block to the memory block without considering whether there is any segment data existing in the memory block is identical to the segment data of another data block.

16. The distorted image correcting method according to claim 15, wherein the segment data of another data block that the memory controller retrieves is identical to a segment data existing in the memory block.
